(19) United States
(12) Patent Application Publication
(10) Pub. No.: US 2008/0292750 A1
(43) Pub. Date: Nov. 27, 2008

(54) Method of Preparing a Food Ingredient and Food Product Having Angiotensin-I-Converting Enzyme Inhibiting Properties and Products Thus Obtained

(75) Inventors: Carolina Baten, Best (NL); Jan-Willem Pieter Boots, Bilthoven (NL)

Correspondence Address: THE WEBB LAW FIRM, P.C., 700 KOPPERS BUILDING, 436 SEVENTH AVENUE, PITTSBURGH, PA, 15219, US

(73) Assignee: CAMOINA NEDERLAND HOLDING B.V., Zaltbommel (NL)

(21) Appl. No.: 10/593,013

(22) PCT Filed: Mar. 19, 2004
(86) PCT No.: PCT/EP2004/002987

§ 371 Date: Aug. 13, 2008

(51) Int. Cl. A23C 9/127

(52) U.S. Cl. 426/43; 426/42; 426/61

(57) ABSTRACT

The invention relates to a method of preparing a food ingredient conferring angiotensin-I-converting enzyme inhibiting properties to the food product comprising the ingredient, which method comprises providing a preparation of one or more protein hydrolysates having angiotensin-I-converting enzyme inhibiting properties, optionally together with one or more other constituents; adding one or more microorganism species to the preparation thus provided; and fermenting the preparation. The ingredient thus obtained has ACE-inhibiting properties and is no longer bitter tasting. The de-bittering can also take place directly in the food product for which the ingredient is intended.

The present invention relates to a method of preparing a food ingredient and food product having angiotensin-I-converting enzyme inhibiting properties and products thus obtained.

In humans, hypertension is generally defined as an arterial pressure of greater than 140/90 mm Hg for an extended period of time. The most common cause is increased peripheral vascular resistance, although it can be caused by prolonged periods of elevated cardiac output.

A study revealed that the prevalence of hypertension (defined as a pressure of 140/90 or above, or treatment with an anti-hypertensive medication) is 27.6% in North America, compared with 44.2% in Europe (55% in Germany ranging down to 38% in Italy). Hypertension treatment (people with hypertension taking anti-hypertensive medication) was reported in 44% of North Americans and in 27% of Europeans. Only 8% of subjects suffering from hypertension in Europe had their condition controlled, compared with 23% in North America.

Hypertension is known as the “silent killer” because it does usually not produce any symptoms until severe damage is already done. It is the number one cause of strokes and can cause heart failure, hardening of the arteries, and kidney damage. Blood pressure can be controlled by lifestyle factors and, in severe cases, prescribed drugs. However, such prescribed drugs may also have severe side effects.

In any case, prevention is better than curing. From the standpoint of preventive medicine there is a significant demand for dietary substances that are effective in preventing or delaying the on-set of hypertension, and that are safe and relatively inexpensive.

U.S. Pat. No. 6,514,941 discloses a casein hydrolysate that is enriched in antihypertensive peptides called C6, C7 and C12. The casein hydrolysate can be obtained by preparing an aqueous solution of the casein and adding an agent that hydrolyses the casein but does not cleave the C6, C7 and C12 peptides, such as trypsin. The peptides thus obtained have angiotensin converting enzyme inhibiting properties.

Angiotensin-I-converting enzyme (ACE) plays a key physiological role in the regulation of several endogenous bio-active peptides and is among others associated with the renin-angiotensin system which regulates blood pressure by the production of the vasoconstrictor peptide angiotensin II and the inactivation of the vasodilator bradykinin. Inhibition of ACE therefore mainly results in an anti-hypertensive effect and most of the hypertension lowering drugs are based on this.

The above described peptides would seem to qualify as a suitable candidate for use in anti-hypertensive food products. However, these peptides have an extremely bitter taste which makes their use in food products as such very difficult.

It is the object of the invention to enable use of ACE inhibiting peptides in food products, such as dairy products.

U.S. Pat. No. 6,214,585 discloses a protein hydrolysate that is substantially free of a bitter taste. It is obtained by incubating a slurry of an enzymatically hydrolysed protein with a culture of Lactobacillus helveticus that is capable of producing peptidases which hydrolyse the bitter tasting polypeptides to give de-bittered substances.

Since this method is based on further hydrolysis of the peptides in the protein hydrolysate it is not suitable for preparing a food ingredient that still retains its ACE inhibiting properties.

In the research that led to the present invention it was found that fermentation of a protein hydrolysate with one or more microorganisms does indeed lead to disappearance of the C12 peptide upon HPLC analysis. Surprisingly, however, the product resulting after fermentation did still show ACE inhibiting activity.

The invention thus relates to a method of preparing a food ingredient conferring angiotensin-I-converting enzyme inhibiting properties to the food product comprising the ingredient, which method comprises:

a) providing a preparation of one or more protein hydrolysates having angiotensin-I-converting enzyme inhibiting properties, optionally together with one or more other constituents;

b) adding one or more microorganism species to the preparation thus provided;

c) fermenting the preparation. The one or more microorganism species are species other than Lactobacillus helveticus. The ingredient thus obtained lacks the bitter taste of the original protein hydrolysate before fermentation and retains ACE-inhibiting activity. The fermented preparation can be used as such as the ingredient or can be further processed, e.g. adding a flavour or drying in order to obtain a powder of the fermented product which can then be added as an ingredient in other products.

The method of the invention can be used with any desired protein hydrolysate provided that the protein hydrolysate has ACE inhibiting properties. The ACE inhibiting properties of a protein hydrolysate can be tested by using furylacryloyl-phenylalanyl-glycyl-glycine (FAPGG) as a substrate and following the decrease in absorbance at 340 nm as described by Vermeirssen et al. (Vermeirssen, V., Van Camp, J. & Verstraete, W. Optimisation and validation of an angiotensin-converting enzyme inhibition assay for the screening of bioactive peptides. J. Biochem. Biophys. Methods 51, 75-87 (2002)).

Suitably, the protein hydrolysate is selected from the group consisting of hydrolysates of plant proteins and animal proteins, in particular of dairy proteins, blood proteins and fish proteins. Suitable hydrolysates of animal proteins comprise casein hydrolysate, whey hydrolysate, beta-lactoglobulin hydrolysate, bovine serum albumin hydrolysate, royal jelly hydrolysate, serum albumin hydrolysate, gelatin hydrolysate, bonito protein hydrolysate. Suitable hydrolysates of plant proteins comprise hydrolysates of spinach proteins, hydrolysates of potato proteins, hydrolysates of soy proteins, hydrolysates of pea proteins, hydrolysates of wheat proteins, hydrolysates of wheat derived gliadin protein, hydrolysates of wheat germ proteins, hydrolysates of sesame proteins, hydrolysates of perilla proteins, hydrolysates of garlic proteins, hydrolysates of kidney bean proteins, hydrolysates of yam proteins, hydrolysates of seaweed proteins, corn gluten hydrolysate. Especially preferred is a casein hydrolysate comprising C6, C7 and C12 peptides. This protein hydrolysate can be obtained as described in U.S. Pat. No. 6,514,941.

The method of the invention can be performed on the protein hydrolysate as such, but for a better growth of the microorganism used for fermentation, additional nutrients, such as tryptone, peptone, may be present. Furthermore, the method can be performed directly in the end product, such as milk to produce yoghurt. Additional nutrients are then not needed.

The method of the invention offers the advantage of greater flexibility in adjusting the level of ACE inhibition in an end product, by adding more or less of the ACE inhibitory peptide or peptide mixture, whereas products in which micro-organisms produce ACE inhibitory peptides in situ, will have a level of ACE inhibition which cannot be manipulated easily.

The fermenting microorganism can be selected from food-grade bacteria, fungi, yeast or moulds. Microorganisms can be tested for their suitability in the method of the invention by incubating a casein hydrolysate, comprising the C12 peptide as described in U.S. Pat. No. 6,514,941, with the candidate microorganism and by testing ACE inhibiting activity (as described above) and taste after a fermentation step at the optimal growth temperature of the particular microorganism.

The incubation time may optionally be prolonged compared to the incubation time typically used for the particular microorganism in order to obtain an optimal de-bittering of the product. The extended fermentation time is advantageously at least 1 hour longer than is normally required for optimal growth.

A suitable microorganism will significantly improve the taste of the end product after fermentation while maintaining the ACE inhibiting activity at a level of at least 1%, preferably at least 5%, more preferably at least 10% or 25%, even more preferably at least 50% or 70% and most preferably at least 90% of the activity before fermentation.

Suitable fermenting bacteria can be selected from the group consisting of Streptococcus thermophilus, Lactobacillus bulgaricus, Lactobacillus acidophilus, Bifidobacterium bifidum and Lactobacillus casei.

Fermented milk products like yoghurt are obtained by incubating milk or a milk-derived product with particular microorganisms, such as lactic acid bacteria. Usually, the raw material is cow's milk, but the milk of other animals, such as goats, sheep, horses can also be used. Milk-derived products comprise for example cream or whey. The milk may be whole milk, but also low-fat or non-fat milk, or recombined milk, made from milk powder dissolved in water.

Traditionally, yoghurt is produced by inoculation of milk with Lactobacillus delbrueckii subsp. bulgaricus and Streptococcus thermophilus as starter cultures. Two basic types of yoghurt exist, namely set yoghurt and stirred yoghurt. Set yoghurt is fermented after being packed, and stirred yoghurt is almost fully fermented in a fermentation tank, after which it is stirred to break up and homogenize the yoghurt gel and packed.

Advantageously, the inventive thought can also be used in a method to directly produce the fermented end product instead of a food ingredient. In that case, the fermentation for preparing the end product can at the same time be used to remove the bitter taste of the protein hydrolysate. The invention thus relates to a method for providing a fermented food product, having angiotensin-I-converting enzyme inhibiting properties, which method comprises:

a) providing a starting material for the food product comprising one or more proteins that already are or can be hydrolysed to obtain a hydrolysate having angiotensin-I-converting enzyme inhibiting properties;

b) adding one or more fermenting microorganisms to the starting material; and

c) fermenting the starting material for a period of time that is optionally longer than the time normally required for optimal growth of the fermenting microorganism to obtain the fermented food product having angiotensin-I-converting enzyme inhibiting properties.

When the period of time is longer than normally required for optimal-growth of the fermenting microorganism it is suitably at least 1 hour longer. It was found that such longer fermentation time leads to an even better de-bittering of the end product.

Furthermore, it was observed that the ACE inhibition of yoghurt products did not decrease significantly during a storage period of at least 8 weeks.

The starting material for the food product can comprise one or more proteins that already are hydrolysed, i.e. it can comprise a hydrolysate. Alternatively, it can comprise a protein that still needs to be hydrolysed to develop the angiotensin-I-converting enzyme inhibiting properties. This hydrolysed protein is subsequently de-bittered to improve the taste of the end product.

In the situation where both fermentation to produce the (de-bittered) end product and preparing the ACE inhibiting peptides are performed at the same time, the fermenting microorganisms may be different for the two tasks. “At the same time” as used herein does not necessarily mean simultaneously, but rather it refers to the fact that hydrolysis to obtain ACE-inhibiting properties and the de-bittering to improve the taste are all performed in the same starting material of the end product. In practice the hydrolysate will be formed first after which it is de-bittered.

The starting material can be a dairy product, in particular whole milk, low-fat milk, non-fat milk, cream or recombined milk, made from milk powder dissolved in water, or a vegetable product, e.g. soy milk or fish paste.

In case the starting material is a dairy product the: fermented food product is suitably yoghurt. Alternatively, the fermented food product can for example be kefir, which can be produced from dairy and vegetable starting materials, Acidophilus milk, cultured cream and koumiss.

For preparing stirred yoghurt by means of the method of the invention, the following commercially available cultures (from Chr. Hansen, Denmark) can be used: YC 280, YC 360, YC X-11 (these indications are commercial indications as used in the catalogue of the firm). For set yoghurt, YC X-11 and YF 3331 can be used. These cultures consist of Streptococcus thermophilus and Lactobacillus bulgaricus. Probiotic cultures comprise ABT-1, ABT-2, which contain Lactobacillus acidophilus, Bifidobacterium bifidum and Streptococcus thermophilus, ABY-2, which contains Lactobacillus acidophilus, Bifidobacterium bifidum, Lactobacillus bulgaricus and Streptococcus thermophilus, BCT-1, which contains Lactobacillus casei, Bifidobacterium bifidum and Streptococcus thermophilus, L. casei 01, which consists of Lactobacillus casei. The invention does not relate to the use of L. helveticus.

The starting culture of kefir comprises a mixture of bacteria and yeasts. In addition to the traditional yoghurt bacteria, kefir comprises Lactobacillus caucasus, Leuconostoc, Acetobacter-species and Streptococcus-species, together with yeasts, such as Saccharomyces-species and Torula-species. These microorganisms that produce the kefir also perform the fermentation step of the method of the invention.

The present invention will be further illustrated in the Examples that follow and that are given for illustration purposes only without the intention to limit the invention in any way.

In the Example reference is made to the following figures:

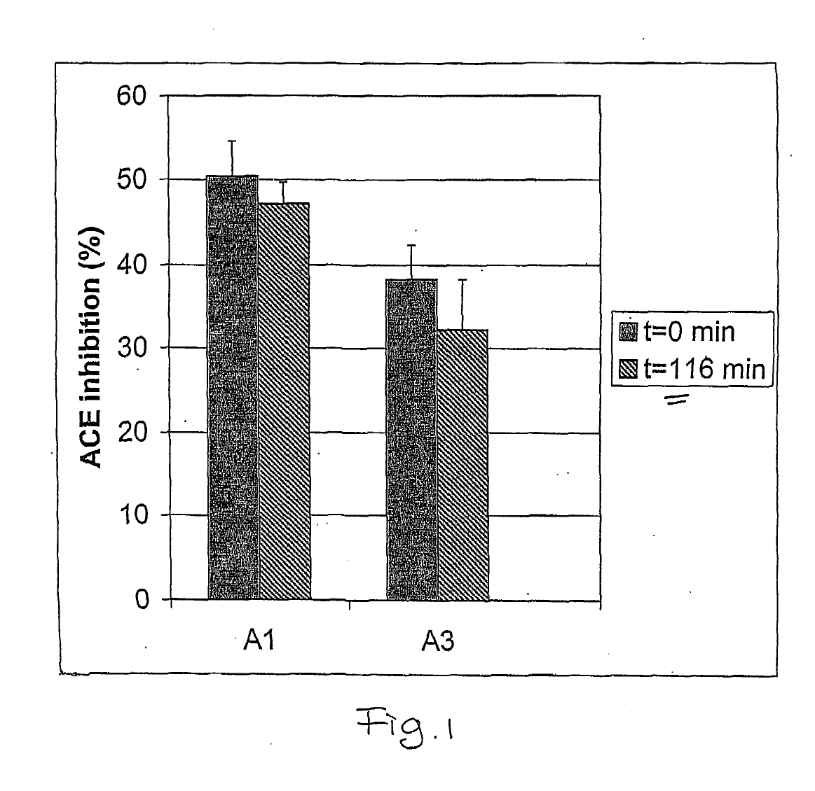

FIG. 1 shows % ACE inhibition of ACE inhibiting peptide in synthetic medium before and after fermentation.

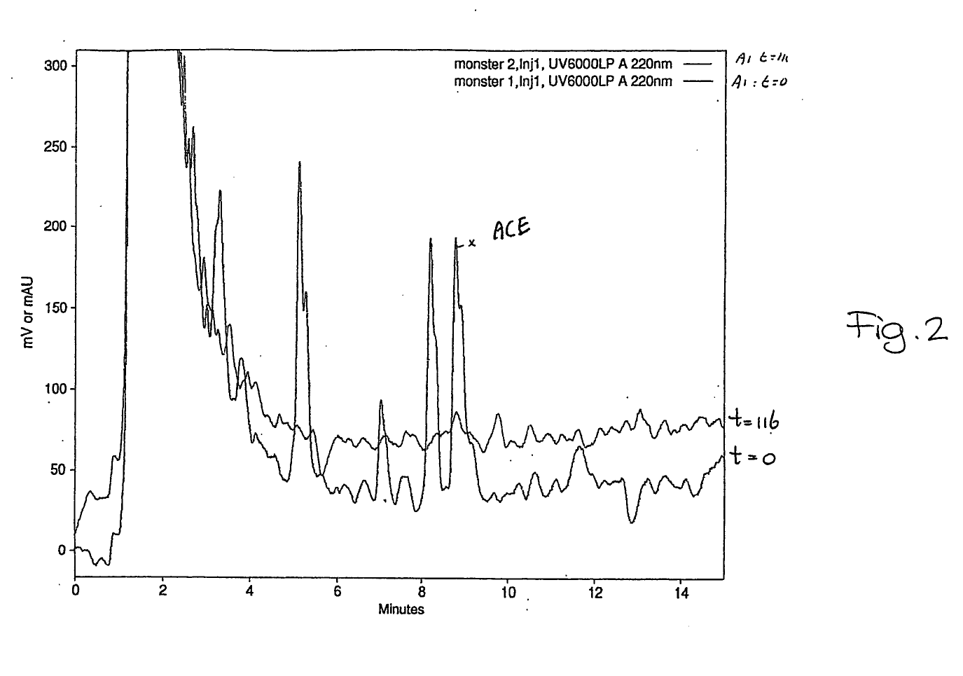

FIG. 2 shows the HPLC data of the samples shown in FIG. 1.

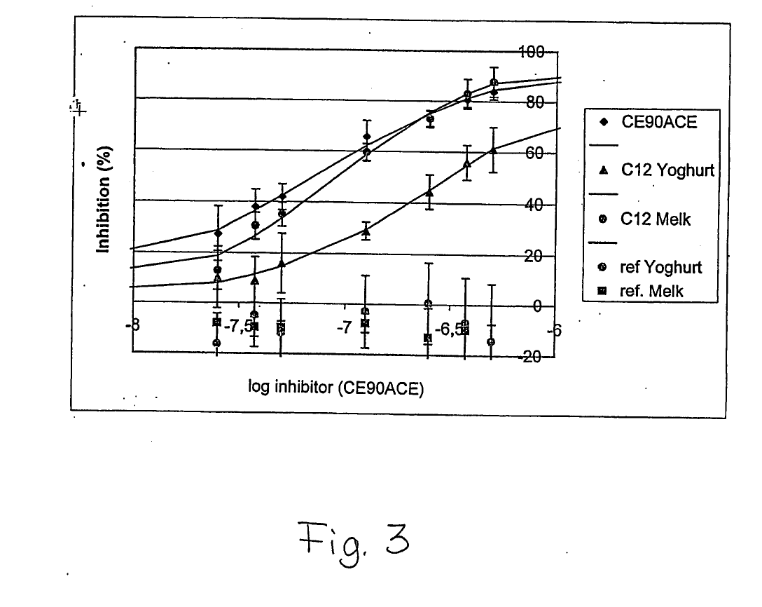

FIG. 3 shows % ACE inhibition of ACE inhibiting peptide in a dairy product before and after fermentation.

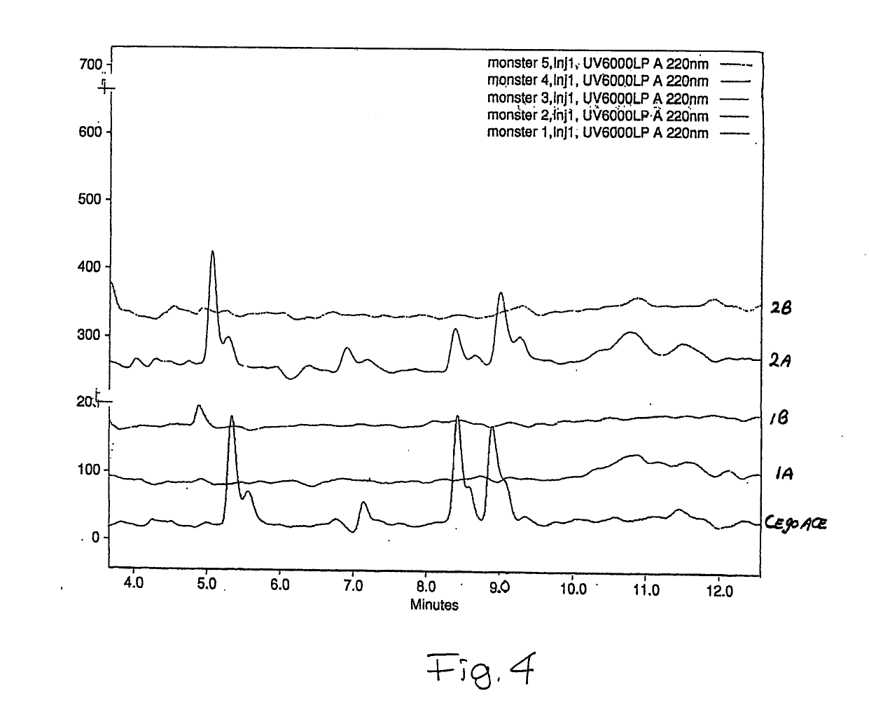

FIG. 4 shows the HPLC data of the samples shown in FIG. 3.

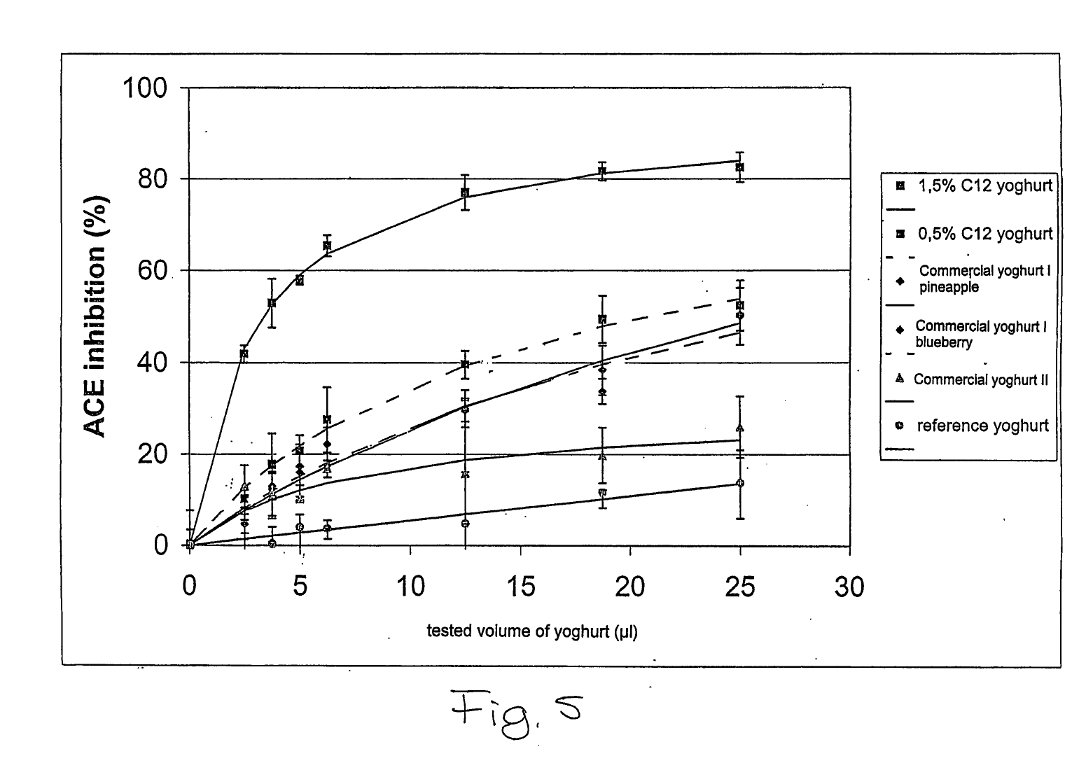

FIG. 5 is a comparison of a yoghurt of the invention with reference yoghurts, which are commercial products from the supermarket, produced by fermenting milk, without additives, specifically with the L. helveticus culture.

### EXAMPLES

### Example 1

### Fermentation of ACE Inhibiting Protein Hydrolysate

In this example it is demonstrated that after fermentation of a protein hydrolysate having ACE inhibiting activity with yoghurt bacteria, the hydrolysate still retains ACE inhibiting activity.

Fermentation was performed in a medium comprising 0.5% yeast extract, 2% trypton, 0.4% NaCl, 0.15% sodium acetate, 0.05% ascorbic acid and either no (sample A3) or 0.5% CE90ACE (DMV International, the Netherlands) (sample A1). The microorganism used was a mixture of L. bulgaricus and S. thermophilus (called 1SSt, obtained from CSK, Leeuwarden, the Netherlands) and fermentation took place at 37° C. during 0 (reference) and 116 minutes.

FIG. 1 shows the results. It follows that after fermentation the ACE-inhibiting activity of the sample is still at an acceptable level. The taste of the sample, although already masked by the other medium ingredients, was less bitter than before fermentation.

HPLC analysis was performed using a YMC pack ODS-A 150/6 mm 5 μm RP-HPLC column from Inacom (Veenendaal, Netherlands). The gradient ranged from 10% acetonitril in water to 90% acetonitril in water in the presence of 1% TFA. Detection was at 220 nm. The results (FIG. 2) show that the C12 peptide, which is present in sample A1 before (t=0) fermentation, has completely disappeared after fermentation.

### Example 2

### Use of ACE Inhibiting Peptides in Yoghurt

In this example, a protein hydrolysate that has ACE inhibiting activity (CE90ACE) is added to milk that is fermented to produce yoghurt. Preparation of yoghurt was carried out by fermenting milk with or without CE90ACE (0.5% w/w) using the ABT-2 culture of Chr. Hansen. Fermentation time was 16 hrs at 37° C., until a pH of 4.45 was reached.

The following samples were tested for their ACE inhibiting activity and taste and subjected to HPLC analysis. For all assays the yoghurt was first centrifuged after which the supernatant was used for analysis.

| Sample | Description |
|---|---|
| CE90ACE | ACE inhibiting hydrolysate in water |
| C12 yoghurt (2B) | yoghurt prepared from milk + CE90ACE (2A) |
| C12 milk (2A) | milk + CE90ACE |
| ref. yoghurt (1B) | yoghurt prepared from reference milk (1A) |
| ref. milk (1A) | milk without CE90ACE |

FIG. 3 shows the results. It was found that after fermentation the C12 yoghurt still had an acceptable level of ACE inhibiting activity, whereas the reference yoghurt, produced from milk without CE90ACE, has no substantial level of ACE inhibiting activity. Furthermore, sample 2B had a significant better taste than sample 2A in that 2B did not taste bitter whereas 2A did. HPLC (FIG. 4) showed that the C12 yoghurt (with CE90ACE) did not have the C12 peptide anymore.

### Example 3

### Comparison with Commercial Yoghurts

Yoghurt was prepared as described in Example 2 using ABT-2, but with two concentrations of CE90ACE (0.5% and 1.5% w/w).

The ACE inhibiting activity of the yoghurt of the invention with two different concentrations of C12 in the starting product (milk) were compared with other commercially available yoghurts that were prepared by fermentation in the absence of ACE inhibiting peptides added to the milk prior to fermentation and specifically using the L. helveticus culture (commercial yoghurts I and II in FIG. 5). FIG. 5 shows that the ACE inhibiting property of the yoghurt of the invention with 1.5% C12 (CE90ACE) is significantly higher. By virtue of the de-bittering effect of the fermentation it is possible to obtain higher concentrations of the ACE inhibiting peptide and an excellent tasting product.

1-9. (canceled)

10: A method of preparing a food product or food ingredient having angiotensin-I-converting enzyme inhibiting properties, comprising:
a) providing a preparation of one or more protein hydrolysates having angiotensin-I-converting enzyme inhibiting properties;
b) mixing the preparation with a constituent selected from the group consisting of whole milk, low-fat milk, non-fat milk, cream and recombined milk;
c) adding one or more microorganisms to the mixture thus obtained; and
d) fermenting the mixture.

11: The method according to claim 10, wherein the one or more protein hydrolysates comprises casein hydrolysate.

12: The method according to claim 11, wherein the casein hydrolysate is a hydrolysate containing C6, C7 and/or C12 peptides.

13: The method according to claim 10, wherein the microorganisms are selected from the group consisting of Streptococcus thermophilus, Lactobacillus bulgaricus, Lactobacillus acidophilus, Lactobacillus casei and Bifidobacterium bifidum.

14: The method according to claim 10, wherein fermenting is continued for a period that is longer than the time normally required for optimal growth of the fermenting microorganism.

15: A food product or food ingredient having angiotensin-I-converting enzyme inhibiting properties, obtained by the method according to claim 10.

16: A method of preparing a food product having angiotensin-I-converting enzyme inhibiting properties, comprising:
a) providing a starting material for the food product selected from the group consisting of whole milk, low-fat milk, non-fat milk, cream and recombined milk;
b) hydrolyzing proteins contained in the starting material to produce a hydrolysate having angiotensin-I-converting enzyme inhibiting properties;
c) adding one or more fermenting microorganisms to the mixture thus obtained; and
d) fermenting the mixture.

17: The method according to claim 16, wherein the microorganisms are selected from the group consisting of Streptococcus thermophilus, Lactobacillus bulgaricus, Lactobacillus acidophilus, Lactobacillus casei and Bifidobacterium bifidum.

18: The method according to claim 16, wherein fermenting is continued for a period that is longer than the time normally required for optimal growth of the fermenting microorganism.

19: A food product having angiotensin-I-converting enzyme inhibiting properties, obtained by the method according to claim 16.

20: A food product as claimed in claim 19, which is yoghurt.

21: A food product as claimed in claim 19, which is selected from kefir, acidophilus milk, cultured cream and koumiss.
